(19) United States
(12) Patent Application Publication
(10) Pub. No.: US 2021/0388787 A1
(43) Pub. Date: Dec. 16, 2021

(54) APPARATUS FOR CONTROLLING ENGINE DEPENDING ON CONTROL OF AIR CONDITIONING OF ECO-FRIENDLY VEHICLE, SYSTEM HAVING THE SAME AND METHOD THEREOF

(71) Applicants: Hyundai Motor Company, Seoul (KR); Kia Motors Corporation, Seoul (KR)

(72) Inventors: Jang Hyo Lee, Hwaseong (KR); In Eok Cho, Incheon (KR)

(21) Appl. No.: 17/094,933

(22) Filed: Nov. 11, 2020

(30) Foreign Application Priority Data
Jun. 16, 2020 (KR) 10-2020-0073109

(51) Int. Cl. F02D 41/06; B60W 10/06; B60W 10/30; B60H 1/00; F02D 41/02

(52) U.S. Cl. CPC F02D 41/068; B60W 10/06; B60W 2510/0676; B60H 1/00964; F02D 41/021; B60W 10/30

(57) ABSTRACT

An apparatus for controlling an engine of a vehicle includes an engine managing part to control warming up the engine at an initial start stage, and an air conditioning controlling part to request the engine managing part to perform an engine start, depending on whether the engine is warming up when control of air conditioning is necessary. The air conditioning controlling part continuously requests the engine managing part to perform the engine start to control the air conditioning until a warming up duration of the engine is terminated during the warning up of the engine.

### CROSS-REFERENCE TO RELATED APPLICATION

This application claims under 35 U.S.C. § 119(a) the benefit of Korean Patent Application No. 10-2020-0073109, filed in the Korean Intellectual Property Office on Jun. 16, 2020, the entire contents of which are incorporated herein by reference.

### BACKGROUND

### (a) Technical Field

The present disclosure relates to an apparatus for controlling an engine depending on the control of air conditioning of an eco-friendly vehicle, a system having the same, and a method thereof, and more particularly, relates to a technology of requesting an engine start (Engine On) by an air conditioning device at an initial stage of a cold start in an eco-friendly vehicle.

### (b) Description of the Related Art

Eco-friendly vehicles include fuel cell vehicles, electric vehicles, plug-in electric vehicles, and hybrid vehicles, and generally include motors to generate driving force.

An air conditioning control device (dual automatic temperature control (DATC), or full automatic temperature control, (FATC)) of a hybrid/plug-in hybrid vehicle secures a heat source, which is required for heating in cold weather (e.g., the winter), through an engine start (Engine On) request (hereinafter, Eng On Req). When the Eng On Req is transmitted from the air conditioning control device, the hybrid vehicle stops the engine to maintain the engine in an idle state in order to ensure the warming performance in electric vehicle (EV) running for improving fuel efficiency and a vehicle stop state.

A conventional air conditioning control device transmits the Eng On Req to an engine managing device based on a preset reference time period after turning on a vehicle system. In other words, the air conditioning control device may transmit the Eng On Req even if the engine is running, in a preset reference time period or less after the vehicle system is turned on. Meanwhile, the air conditioning control device may transmit the Eng On Req only in the EV mode when the preset reference time period is exceeded after the vehicle system is turned on and when the engine is stopped.

As described above, the conventional air conditioning control device does not transmit the Eng On Req for controlling air conditioning, because the engine is being starting through warming up, when air conditioning is necessary to be controlled during the warning up of the engine after five seconds is elapsed from the initial stage of the cold start.

Therefore, as the engine is turned off at a time point at which the warming up of the engine is terminated, and the air conditioning control device transmits the Eng On Req for controlling the air conditioning at a time point at which the engine is turned off Accordingly, the engine is restarted immediately as soon as the engine is turned off, so the user may feel the sense of difference as illustrated in the graph of FIG. 1.

### SUMMARY

An aspect of the present disclosure provides an apparatus for controlling an engine of a vehicle, a system having the same, and a method thereof, capable of continuously transmitting an engine start request signal to control air conditioning until a warming up duration of the engine is terminated when the air conditioning is necessary to be controlled and when the engine is warming up, thereby preventing the engine from being restarted after being turned off when the warming up of the engine is terminated, such that robustness is secured in controlling the engine to be turned on or off and the sense of different is minimized.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling an engine of a vehicle may include an engine managing part to control warming up the engine at an initial start stage, and an air conditioning controlling part to request the engine managing part to perform an engine start, depending on whether the engine is warning up when control of air conditioning is necessary. The air conditioning controlling part may continuously request the engine managing part to perform the engine start to control the air conditioning until a warming up duration of the engine is terminated during the warming up of the engine.

According to an embodiment, the air conditioning controlling part may continuously request the engine start to control the air conditioning when the control of the air conditioning is determined as being continuously necessary after the warming up duration of the engine is terminated.

According to an embodiment, the air conditioning controlling part may stop requesting the engine managing part to perform the engine start when the air conditioning is not determined as being continuously necessary after the warning up duration of the engine is terminated.

According to an embodiment, the air conditioning controlling part may request the engine managing part to perform the engine start to control the air conditioning when control of the air conditioning is determined as being necessary in a state that the engine is turned off after the warming up duration of the engine is terminated.

According to an embodiment, the air conditioning controlling part may determine whether the engine start is necessary to control the air conditioning based on an external temperature, a setting temperature, and an on or off state of an air conditioning device.

According to an embodiment, the engine managing part may perform the warming up of the engine until a cooling water temperature of the engine reaches a first condition.

According to an embodiment, the air conditioning controlling part may continuously transmit, to the engine managing part, an engine start request signal for controlling the air conditioning until the cooling water temperature reaches a second condition which is preset, after the warming up of the engine is terminated.

According to an embodiment, the engine managing part may determine whether the warming up of the engine is necessary depending on a cooling water temperature of the engine.

According to an embodiment, the engine managing part determine that the warming up of the engine is necessary when the cooling water temperature of the engine is equal to or less than a first condition, which is preset, and transmits an engine warning up request signal to the air conditioning controlling part.

According to an embodiment, the air conditioning controlling part may determine a warming up state of the engine based on the engine warming up request signal.

According to an embodiment, the apparatus may further include a communication part to make communication between the engine managing part and the air conditioning controlling part.

According to another aspect of the present disclosure, a vehicle system may include an engine managing device (EMS) to control warming up of an engine at an initial start stage, and an air conditioning controlling device to request the engine managing device to perform an engine start, depending on whether the engine is warming up, and the air conditioning controlling device may continuously request the engine managing device to perform the engine start to control the air conditioning until a warming up duration of the engine is terminated during the warming up of the engine.

According to an embodiment, the air conditioning controlling device may include a dual auto temperature control (DATC) or a full automatic temperature control (FATC).

According to an embodiment, the air conditioning controlling device may continuously request the engine managing device to perform the engine start to control the air conditioning when control of the air conditioning is determined as being continuously necessary after the warming up duration of the engine is terminated.

According to another aspect of the present disclosure, a method for controlling an engine of a vehicle may include controlling, by an engine managing part, warming up the engine at an initial start stage, and continuously requesting, by an air conditioning controlling part, an engine managing part to perform an engine start to control air conditioning, depending on whether the engine is warming up when control of the air conditioning is necessary. The continuously requesting the engine managing part to perform the engine start may include continuously requesting the engine managing part to perform the engine start to control the air conditioning until a warming up duration of the engine is terminated during the warming up of the engine.

According to an embodiment, the method may further include continuously requesting the engine managing part to perform the engine start to control the air conditioning when the control of the air conditioning is determined as being continuously necessary after the warming up duration of the engine is terminated.

According to an embodiment, the method may further include stopping requesting the engine managing part to perform the engine start when the control of the air conditioning is not determined as being continuously necessary after the warming up duration of the engine is terminated.

According to an embodiment, the method may further include determining whether the air conditioning is necessary to be controlled, based on an external temperature, a setting temperature, and an on or off state of an air conditioning device.

According to an embodiment, the controlling of the warning up the engine at an initial start stage may include performing the warming up of the engine until a cooling water temperature of the engine reaches a first condition.

According to an embodiment, the continuously requesting of the engine start may include continuously transmitting, to the engine managing part, an engine start request signal for controlling the air conditioning until the cooling water temperature reaches a second condition which is preset, after the warming up of the engine is terminated.

### BRIEF DESCRIPTION OF THE DRAWINGS

The above and other objects, features and advantages of the present disclosure will be more apparent from the following detailed description taken in conjunction with the accompanying drawings:

FIG. 1 (PRIOR ART) is a graph illustrating a problem encountered in the related art regarding engine control;

FIG. 2 is a block diagram illustrating the configuration of a vehicle system including an apparatus for controlling an engine of a vehicle, according to an embodiment of the present disclosure;

FIG. 3 is a view illustrating a vehicle system employing an apparatus for controlling an engine of a vehicle, according to an embodiment of the present disclosure;

FIGS. 4 to 6 are timing diagrams illustrating a method for controlling an engine start when controlling air conditioning of an apparatus for controlling an engine of a vehicle, according to an embodiment of the present disclosure;

FIG. 7 is a flowchart illustrating a method for controlling an engine of a vehicle when controlling air conditioning, according to an embodiment of the present disclosure; and

FIG. 8 is a view illustrating a computing system, according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to accompanying drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. The terms are used only to distinguish relevant components from other components, and the nature, the order, or the sequence of the relevant components is not limited to the terms. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses a technology of controlling an engine start when controlling air conditioning using an engine warming up signal.

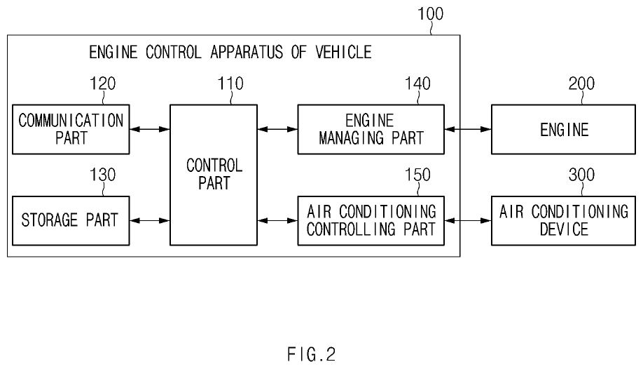

Hereinafter, embodiments of the present disclosure will be described in detail with reference to FIGS. 2 to 8.

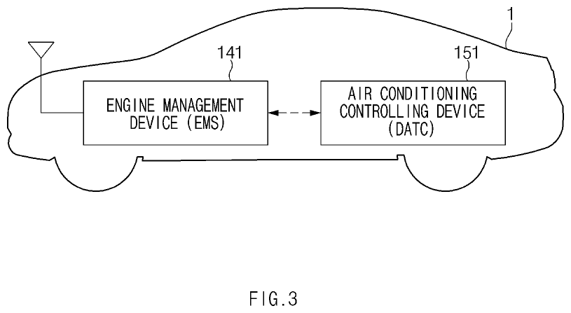

FIG. 2 is a block diagram illustrating the configuration of a vehicle system including an apparatus for controlling an engine of a vehicle, according to an embodiment of the present disclosure, and FIG. 3 is a view illustrating a vehicle system employing an apparatus for controlling an engine of a vehicle, according to an embodiment of the present disclosure.

According to the present disclosure, the vehicle system may include an apparatus (engine control apparatus) 100 for controlling an engine of a vehicle, an engine 200, and an air conditioning device 300.

According to the present disclosure, the vehicle system may be a system of a hybrid vehicle or a plug-in hybrid vehicle, for example. The hybrid vehicle may run in a driving mode including an electric vehicle (EV) mode, which is a pure electric vehicle mode using only power of a motor, a hybrid electric vehicle (HEV) mode employing the torque of an engine as main power and employing the torque of a motor as auxiliary power, and a regenerative braking mode to recover braking energy or inertia energy through power generation of the motor when the vehicle is braked or runs due to inertia, to charge the braking energy or the inertia energy. Accordingly, the hybrid vehicle may start the engine to control air conditioning even though the engine is turned off in the EV mode.

The engine control apparatus 100 of the vehicle may control warming up of the engine at the initial start stage, and may request the engine start depending on whether the engine is warmed up when the air conditioning is necessary. In particular, the engine control apparatus 100 continuously requests the engine start to control the air conditioning until the warming up duration of the engine is terminated, thereby preventing the engine from being turned off at the time point at which the warming up of the engine is terminated, even though the engine start is continuously needed to control the air conditioning.

The engine 200 is controlled by an engine management part 140 to drive the motor of the vehicle. As provided herein, the engine management part 140 may be a portion of the engine control apparatus 100, and preferably is a controller including a processor and/or memory.

The air conditioning device 300 may transmit air having a higher or lower temperature into the vehicle, in response to a control signal output by an air conditioning controlling part 150.

Referring to FIG. 2, according to an embodiment of the present disclosure, the engine control apparatus 100 may be implemented inside a vehicle. In this case, the engine control apparatus 100 of the vehicle may be formed integrally with the internal control units of the vehicle or may be implemented separately from the internal control units of the vehicle to be connected with the internal control units of the vehicle through a separate connector.

The engine control apparatus 100 may include a control part 110, a communication part 120, a storage part 130, the engine managing part 140, and the air conditioning controlling part 150. In this case, according to the present embodiment, the control part 110, the engine managing part 140, and the air conditioning controlling part 150 of the engine control apparatus 100 of the vehicle may be implemented with at least one processor. For example, the air conditioning controlling part 150 preferably is a controller including a processor and/or memory.

The control part 110 may control the overall operation of the components. The control part 110 may be electrically connected with the communication part 120, the storage part 130, the engine managing part 140, and the air conditioning controlling part 150, may electrically control each component, and may be an electric circuit that executes software commands. Accordingly, the control part 110 may perform various data processing and calculation, to be described below. The control part 110 may be, for example, a hybrid control unit, an electronic control unit, a micro-controller unit (MCU) mounted in the vehicle.

The communication part 120 may include a communication module which supports a communication interface with electronic parts and/or control units provided in a vehicle. For example, the communication module may perform in-vehicle communication through a controller area network (CAN) communication, a local interconnect network (LIN) communication, a FlexRay communication, and in-vehicle communication.

For example, the communication part 120 may transmit or receive an Eng On Req signal and an engine warming up signal between the engine managing part 140 and the air conditioning controlling part 150.

The storage part 130 may store information received by the communication part 120, data obtained by the engine managing part 140 and the air conditioning controlling part 150, or data and/or an algorithm necessary for the apparatus 100 to operate.

In addition, the storage part 130 may be implemented with at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The engine managing part 140 may control warming up of an engine at the initial start stage.

The engine managing part 140 may determine whether the warming up of the engine is necessary, using a cooling water temperature at the initial start stage.

The engine managing part 140 may determine the warming up of the engine as being necessary, when the cooling water temperature is equal to or less than a first critical value which is preset. In other words, the engine managing part 140 warms up the engine to increase the temperature when the cooling water temperature is lower than the preset temperature.

When the warming up of the engine is necessary, the engine managing part 140 transmits a signal (engine warming up request signal) for requesting to warm up the engine to start warming up cooling water of the engine, and transmits the engine warming up request signal even to the air conditioning controlling part 150. Accordingly, the air conditioning controlling part 150 may determine a warming up state of the engine using the engine warming up request signal.

Accordingly, the air conditioning controlling part 150 may recognize that the engine is currently warming up, when receiving the engine warming up request signal, and may continuously request the engine managing part 140 to perform the engine start to control air conditioning until the warming up duration of the engine is terminated.

When determining that the air conditioning is necessary to be continuously controlled after the warming up duration of the engine is terminated, the air conditioning controlling part 150 continuously transmits the request for the engine start to control the air conditioning such that the engine start is continuously maintained even if the warming up of the engine is terminated, thereby preventing the engine from being instantly restarted to control the air conditioning after tuning off the engine as the engine has been warmed up.

The air conditioning controlling part 150 may stop the request for the engine start when the control of the air conditioning is not continuously necessary after the warming up duration for the engine is terminated. Accordingly, the engine may be turned off Thereafter, the air conditioning controlling part 150 may transmit, to the engine managing part 140, the request for the engine start to control the air conditioning, when determining that the air conditioning is necessary to controlled, after the engine is turned off as the warming up duration for the engine is terminated.

The air conditioning controlling part 150 may determine whether a warming load of the air conditioning device 300 is present while the cooling water temperature of the engine is warming up. That the warming load is present may refer to that the engine start is necessary as the warming is necessary. In this case, the air conditioning controlling part 150 may determine whether the engine start to control the air conditioning is necessary, based on an external temperature, a setting temperature, and an on/off state of the air conditioning device. In other words, the air conditioning controlling part 150 determines that the warming load is present, when the external temperature is less than a preset critical temperature, when the setting temperature of the air conditioning device exceeds a preset critical value, and when the air conditioning device 300 is in a blow on state. In this case, the air conditioning controlling part 150 may determine that the warming load is present, when the external temperature is low, when the setting temperature of the air conditioning device is higher than the preset critical value, and when the air conditioning device is turned off.

Accordingly, the air conditioning controlling part 150 transmits a signal (engine start request signal) for requesting an engine start to the engine managing part 140 when the warming load is present during the warming up of the engine. Meanwhile, when the warming load is absent, that is, when the external temperature is not less than the preset critical temperature, when the setting temperature of the air conditioning device does not exceed the preset critical value, or when the air conditioning device is not the blower on state, the air conditioning controlling part 150 determines that the warming is not necessary, and does not transmit the engine start request signal to the engine managing part 140.

In addition, the engine managing part 140 performs the warming up of the engine until the cooling water temperature reaches the first critical value (first condition), determines that the warming up of the engine is not necessary, when the cooling water temperature exceeds the first critical value, and determines whether the cooling water temperature exceeds a preset second critical value and is less than a third critical value, that is, when the cooling water temperature is equal to or less than the third threshold value (second condition). In other words, the engine managing part 140 determines whether the request for the engine start to control air conditioning is necessary, although the warming up of the engine is terminated as the cooling water temperature is increased. In this case, the first condition and the second condition may be determined depending on experimental values in advance.

The air conditioning controlling part 150 continuously transmits, to the engine managing part 140, the engine start request signal for controlling the air conditioning until the cooling water temperature reaches the second condition, which is preset, after the warming up of the engine is terminated, such that the engine start is performed.

The engine managing part 140 may transmit a signal (engine warming up terminating signal) for terminating the warming up of the engine to the engine 200 and the air conditioning controlling part 150, and notify the air conditioning controlling part 150 that the cooling water temperature is sufficiently increased, when the warming up of the engine is terminated, and when the cooling water temperature is not necessary to be increased currently, that is, when the cooling water temperature is sufficiently increased. Accordingly, air conditioning controlling part 150 does not transmit the engine start request signal for controlling the air conditioning.

The engine managing part 140 may transmit the engine warming up terminating signal to the air conditioning controlling part 150, when the cooling water temperature is not necessary to be increased currently although the warming up of the engine is terminated, that is, when the engine start for controlling air conditioning is necessary.

Accordingly, the air conditioning controlling part 150 may recognize that the warming up of the engine is terminated, and may determine whether the warming load of the air conditioning device 300 is present in the state that the warming up of the engine is terminated. In other words, the air conditioning controlling part 150 determines that the warming load is present, when the external temperature is less than a preset critical temperature, when the setting temperature of the air conditioning device exceeds a preset critical value, and when the air conditioning device 400 is in the blow on state.

Meanwhile, when the warming load is absent after the warming up of the engine is terminated, that is, when the external temperature is not less than the preset critical temperature, when the setting temperature of the air conditioning device does not exceed the preset critical value, or when the air conditioning device is not the blower on state, the air conditioning controlling part 150 determines that the warming is not necessary, and does not transmit the engine start request signal to the engine managing part 140.

Meanwhile, the air conditioning controlling part 150 notifies the engine managing part 140 that the warming load is present, when the warming load is present after the warming up of the engine is terminated.

Accordingly, the engine managing part 140 determines whether the engine is in an off state by determining whether the vehicle is currently in a power train (PT) mode. In other words, the engine managing part 140 determines that the engine is in the off state when the PT mode is ‘0’, and determines that the engine is in the on state, that is, a driving mode state when the PT mode is ‘1’, and notifies the air conditioning controlling part 150 that the vehicle is currently in the PT mode.

Accordingly, when the warming up of the engine is terminated, when the warming load is present, and when the vehicle is not in the PT mode, that is, when the engine is in the off state, the air conditioning controlling part 150 transmits, to the engine managing part 140, the engine start request signal for controlling the air conditioning.

To the contrary, when the warming up of the engine is terminated, when the warming load is present, and when the vehicle is in the PT mode, that is, when the engine is in the on state, the air conditioning controlling part 150 does not transmit the engine start request signal for controlling the air conditioning.

In FIG. 2, the engine managing part 140 and the air conditioning controlling part 150 are illustrated in a unified form, but may be implemented as independent devices separated from each other.

In this case, the engine managing part 140 may be implemented with an engine managing device (engine management system; EMS) 141 as illustrated in FIG. 3.

The air conditioning controlling part 150 may be implemented with a dual auto temperature control 151 (DATC), or a full automatic temperature control (FATC) as illustrated in FIG. 3. In particular, the DATC may independently control the temperatures of a driver seat and a passenger seat. When an air vent is present at a rear seat, the temperature may be independently controlled with respect to the rear set to control the optimal air conditioning state.

According to the present embodiment, the engine managing device (engine management system; EMS) 141 and the air conditioning controlling device (DATC) 151 having the above operations may be implemented in the form of an independent hardware device including a memory and a processor to process each operation, and may be run in the form included in another hardware device such as a microprocessor or a general purpose computer system.

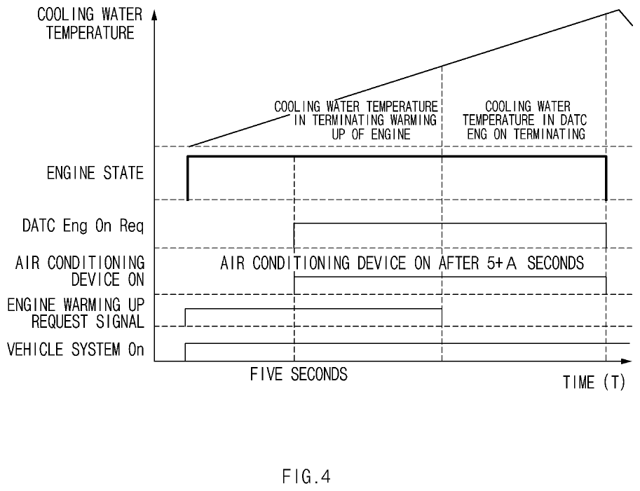

FIGS. 4 to 6 are timing diagrams illustrating a method for controlling an engine start when controlling air conditioning of the engine control apparatus, according to an embodiment of the present disclosure.

FIG. 4 is a timing diagram for case #1, and a timing diagram illustrating the state of an engine when the air conditioning device is turned on after five seconds are elapsed from the start-up of the vehicle.

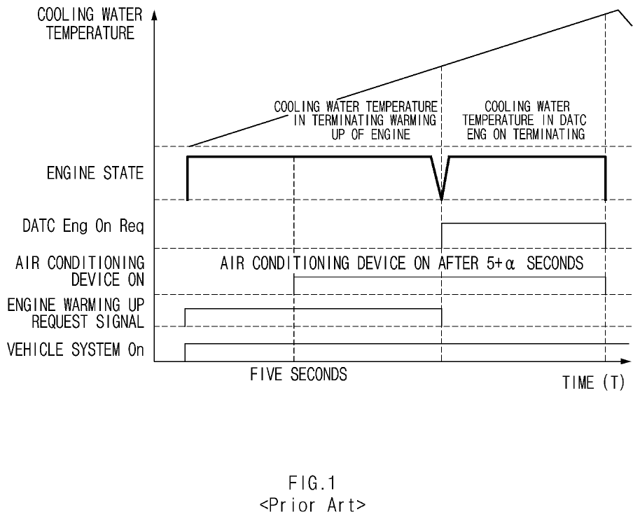

As illustrated in FIG. 1 of the related art, when the controlling of the air conditioning is necessary in the state that five seconds after the vehicle system is turned on, and when the engine is still warming up, since the engine is in the on state, the engine start request signal for controlling the air conditioning is not transmitted. Accordingly, the engine start request signal is transmitted as soon as the engine is turned off after waiting for the off state of the engine. Accordingly, the engine of the vehicle is turned off at the time point at which the warming up of the engine is terminated, and then restarted immediately when the engine start request signal is received.

To the contrary, referring to FIG. 4, when the controlling of the air conditioning is necessary in the state that five seconds are elapsed after the vehicle system is turned on, and when the engine is still warming up, even though the engine is in the on state, the engine start request signal (DATC Eng On Req) for controlling the air conditioning is continuously output. Accordingly, even if the warming up of the engine is terminated, the engine is continuously maintained to be in the on state. Accordingly, the engine is prevented from being immediately restarted by the engine start request signal (DATC Eng On Req) after the engine is turned off when the warming up of the engine is terminated.

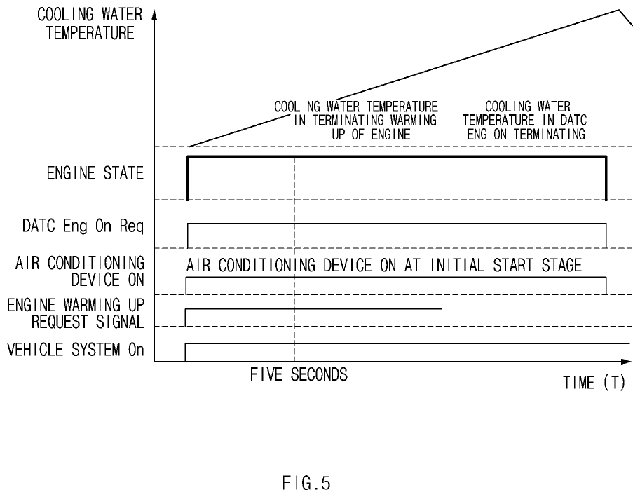

FIG. 5 is a timing diagram for case #2, and a timing diagram illustrating the state of an engine when an air conditioning device is turned on while a vehicle is started.

Referring to FIG. 5, the air conditioning device is turned on as the vehicle system is turned on. In this case, since the engine is warming up, even though the engine is turned on, as the engine start request signal (DATC Eng On Req) for controlling the air conditioning is continuously output. Accordingly, even if the warming up of the engine is terminated, the engine is continuously maintained to be in the on state.

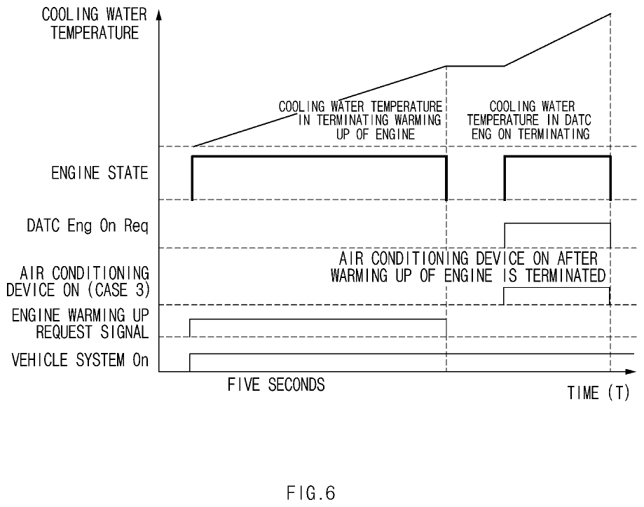

FIG. 6 is a timing diagram for case #3, and a timing diagram illustrating the state of an engine when an air conditioning device is turned on after the warming up of the engine is terminated.

Referring to FIG. 6, the air conditioning device is turned on after the warming up of the engine is terminated. In this case, the engine is turned off when the warming up of the engine is terminated, and the air conditioning device is turned on. Accordingly, it may be recognized that, as the engine start request signal (DATC Eng On Req) for controlling the air conditioning is continuously output, the engine is restarted.

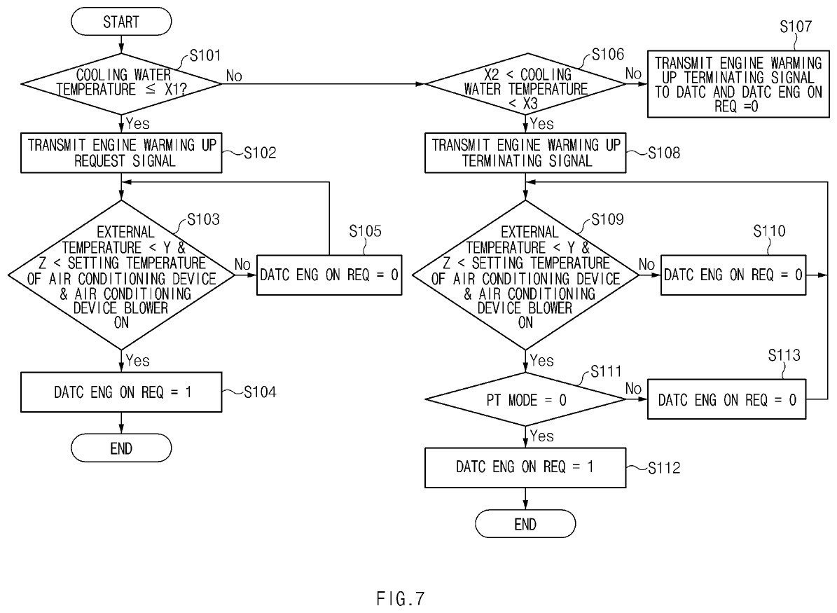

Hereinafter, a method for controlling a vehicle engine will be described in detail according to an embodiment of the present disclosure. FIG. 7 is a flowchart illustrating a method for controlling an engine when controlling air conditioning of a vehicle, according to an embodiment of the present disclosure.

Hereinafter, the engine control apparatus 100 of FIG. 2 may perform the process of FIG. 7. The following description will be made on the assumption that the process of FIG. 7 is performed by the engine managing device 141 and the air conditioning controlling device 151 of FIG. 2 for the convenience of explanation. In addition, in the following description made with reference to FIG. 7, it may be understood that operations described as being performed by the apparatus 100 are controlled by the processor 140 of each of the engine managing device 141 and the air conditioning controlling device 151.

Referring to FIG. 7, the engine managing device 141 may determine whether the warming up of the engine is necessary, using a cooling water temperature at the initial start stage.

The engine managing device 141 may determine whether the warming up of the engine is necessary, when the cooling water temperature is equal to or less than the first critical value (X1) which is preset (S101).

When the warming up of the engine is necessary, the engine managing device 141 transmits an engine warming up request signal to start warming up cooling water of the engine, and then transmits the engine warming up request signal even to the air conditioning controlling device 151 (S102).

Accordingly, the air conditioning controlling device 151 recognizes that the engine is currently warming up, when receiving the engine warming up request signal. The air conditioning controlling device 151 determines whether the warming load of the air conditioning device 300 is present while the cooling water temperature of the engine is warmed up (S103). In other words, the air conditioning controlling device 151 determines that the warming load is present, when the external temperature is less than a preset critical temperature (Y), when the setting temperature of the air conditioning device exceeds a preset critical value (Z), and when the air conditioning device 300 is in the blow on state. In this case, the warming load may refer to that the warming is necessary, and it may be determined that the warming load is present, when the external temperature is low, when the setting temperature of the air conditioning device is higher than the preset critical value, and when the air conditioning device is turned on.

Accordingly, the air conditioning controlling device 151 transmits the engine start request signal to the engine managing device 141 when the warming load is present during the warming up of the engine (S104). Meanwhile, when the warming load is absent, that is, when the external temperature is not less than the preset critical temperature (Y), when the setting temperature of the air conditioning device does not exceed the preset critical value (Z), or when the air conditioning device 300 is not in the blower on state, the air conditioning controlling device 151 determines that the warming is not necessary, and does not transmit the engine start request signal to the engine managing device 141 (S105).

In addition, the engine managing device 141 determines that the warming up of the engine is not necessary, when the cooling water temperature exceeds the first critical value (X1), and determines whether the cooling water temperature exceeds a preset second critical value (X2) and is less than a third threshold value (X3) (S106). In other words, the engine managing device 141 determines whether the request for the engine start to control air conditioning is necessary, even though the warming up of the engine is terminated as the cooling water temperature is increased.

The engine managing device 141 transmits the engine warming up terminating signal without transmitting the engine start request signal for controlling the air conditioning, when the cooling water temperature exceeds the third critical value, that is, when the cooling water temperature is not necessary to be increased any more, after the warming up of the engine is terminated as the cooling water temperature is sufficiently increased (S107).

The engine managing device 141 may transmit the engine warming up terminating signal to the air conditioning controlling device 151, when a present cooling water temperature is necessary to be increased even though the warming up of the engine is terminated, that is, when the engine start for controlling the air conditioning is necessary (S108).

Accordingly, the air conditioning controlling device 151 may recognize that the warming up of the engine is terminated, and may determine whether the warming load of the air conditioning device 300 is present in the state that the warning up of the engine is terminated (S109). In other words, the air conditioning controlling device 151 determines that the warming load is present, when the external temperature is less than the preset critical temperature (Y), when the setting temperature of the air conditioning device exceeds the preset critical value (Z), and when the air conditioning device 300 is in the blow on state.

Meanwhile, when the warming load is absent after the warming up of the engine is terminated, that is, when the external temperature is not less than the preset critical temperature (Y), when the setting temperature of the air conditioning device does not exceed the preset critical value (Z), or and when the air conditioning device is not the blower on state, the air conditioning controlling device 151 determines that the warming is not necessary, and does not transmit the engine start request signal to the engine managing device 141 (S110).

Meanwhile, the air conditioning controlling device 151 notifies the engine managing device 141 that the warming load is present, when the warming load is present after the warming up of the engine is terminated.

Accordingly, the engine managing part 140 determines whether the engine is in an off state by determining whether the vehicle is currently in the power train (PT) mode (S111). In other words, the engine managing device 141 determines that the engine is in the off state when the PT mode is ‘0’, determines that the engine is in the on state, that is, a driving mode state when the PT mode is ‘1’, and notifies the air conditioning controlling device 151 that the vehicle is currently in the PT mode.

Accordingly, when the warming up of the engine is terminated, when the warming load is present, and when the vehicle is not in the PT mode, that is, when the engine is in the off state, the air conditioning controlling device 151 transmits, to the engine managing device 141, the engine start request signal for controlling the air conditioning (S112).

To the contrary, when the warming up of the engine is terminated, when the warming load is present, and when the vehicle is in the PT mode, that is, when the engine is in the on state, the air conditioning controlling device 151 does not transmit the engine start request signal for controlling the air conditioning.

As described above, according to the present disclosure, the engine start request signal is transmitted to control the air conditioning regardless of an on or off state of the engine during the warming up of the engine at the initial stage of the cold start, and the on or off state of the engine is determined after the warming up duration is terminated, and the engine start request signal for controlling the air conditioning when the engine is in the off state, thereby continuously transmitting the engine start request signal until the warming up of the engine is terminated. Accordingly, the engine is prevented from being immediately restarted in response to the engine start request signal for controlling the air condition after the engine is turned off when the warming up of the engine is terminated.

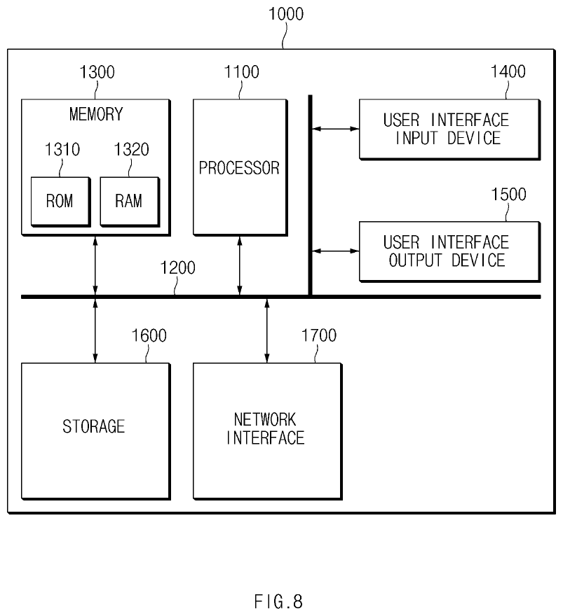

FIG. 8 is a view illustrating a computing system, according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically erasable and programmable ROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and the storage medium may reside as separate components of the terminal of the user.

According to the present disclosure, the engine start request signal to control air conditioning may be continuously transmitted until the warming up duration of the engine is terminated when the air conditioning is necessary to be controlled and when the engine is warming up, thereby preventing the engine from being restarted after being turned off when the warming up of the engine is terminated, such that robustness is secured in controlling the engine to be turned on or off and the sense of different is minimized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling an engine of a vehicle, the apparatus comprising:
an engine managing part configured to control warning up the engine at an initial start stage; and
an air conditioning controlling part configured to request the engine managing part to perform an engine start, depending on whether the engine is warming up when control of air conditioning is necessary,
wherein the air conditioning controlling part continuously requests the engine managing part to perform the engine start to control the air conditioning until a warming up duration of the engine is terminated during the warming up of the engine.

2. The apparatus of claim 1, wherein the air conditioning controlling part continuously requests the engine managing part to perform the engine start to control the air conditioning when the control of the air conditioning is determined as being continuously necessary after the warming up duration of the engine is terminated.

3. The apparatus of claim 1, wherein the air conditioning controlling part stops requesting the engine managing part to perform the engine start when control of the air conditioning is not determined as being continuously necessary after the warming up duration of the engine is terminated.

4. The apparatus of claim 3, wherein the air conditioning controlling part requests the engine managing part to perform the engine start to control the air conditioning when the control of the air conditioning is determined as being necessary in a state that the engine is turned off after the warming up duration of the engine is terminated.

5. The apparatus of claim 1, wherein the air conditioning controlling part determines whether the engine start is necessary to control the air conditioning based on an external temperature, a setting temperature, and an on or off state of an air conditioning device.

6. The apparatus of claim 1, wherein the engine managing part performs the warming up of the engine until a cooling water temperature of the engine reaches a first condition.

7. The apparatus of claim 6, wherein the air conditioning controlling part continuously transmits, to the engine managing part, an engine start request signal for controlling the air conditioning until the cooling water temperature reaches a second condition which is preset, after the warming up of the engine is terminated.

8. The apparatus of claim 1, wherein the engine managing part determines whether the warming up of the engine is necessary depending on a cooling water temperature of the engine.

9. The apparatus of claim 8, wherein the engine managing part determines that the warming up of the engine is necessary when the cooling water temperature of the engine is equal to or less than a first condition, which is preset, and transmits an engine warming up request signal to the air conditioning controlling part.

10. The apparatus of claim 9, wherein the air conditioning controlling part determines a warming up state of the engine based on the engine warning up request signal.

11. The apparatus of claim 1, further comprising:
a communication part configured to make communication between the engine managing part and the air conditioning controlling part.

12. A vehicle system comprising:
an engine managing device (EMS) configured to control warming up of an engine at an initial start stage; and
an air conditioning controlling device configured to request the engine managing device to perform an engine start, depending on whether the engine is warming up,
wherein the air conditioning controlling device continuously requests the engine managing device to perform the engine start to control the air conditioning until a warming up duration of the engine is terminated during the warming up of the engine.

13. The vehicle system of claim 12, wherein the air conditioning controlling device includes a dual auto temperature control (DATC) or a full automatic temperature control (FATC).

14. The vehicle system of claim 12, wherein the air conditioning controlling device continuously requests the engine managing device to perform the engine start to control the air conditioning when control of the air conditioning is determined as being continuously necessary after the warming up duration of the engine is terminated.

15. A method for controlling an engine of a vehicle, the method comprising:
controlling, by an engine managing part, warming up the engine at an initial start stage; and
continuously requesting, by an air conditioning controlling part, the engine managing part to perform an engine start to control air conditioning, depending on whether the engine is warming up when control of the air conditioning is necessary,
wherein the continuously requesting of the engine start includes:
continuously requesting the engine managing part to perform the engine start to control the air conditioning until a warming up duration of the engine is terminated during the warming up of the engine.

16. The method of claim 15, further comprising:
continuously requesting the engine managing part to perform the engine start to control the air conditioning when the control of the air conditioning is determined as being continuously necessary after the warming up duration of the engine is terminated.

17. The method of claim 16, further comprising:
stopping requesting the engine managing part to perform the engine start when the control of the air conditioning is not determined as being continuously necessary after the warming up duration of the engine is terminated.

18. The method of claim 16, further comprising:
determining whether the air conditioning is necessary to be controlled, based on an external temperature, a setting temperature, and an on or off state of an air conditioning device.

19. The method of claim 16, wherein the controlling of the warming up the engine at an initial start stage includes:
performing the warning up of the engine until a cooling water temperature of the engine reaches a first critical value.

20. The method of claim 19, wherein the continuously requesting of the engine start includes:
continuously transmitting, to the engine managing part, an engine start request signal for controlling the air conditioning until the cooling water temperature reaches a second critical value, which is preset, after the warming up of the engine is terminated.
